(19) United States
(12) Patent Application Publication
(10) Pub. No.: US 2025/0268421 A1
(43) Pub. Date: Aug. 28, 2025

(54) DOUBLE-SIDE CONTACT GRILL

(71) Applicants: Marmon Foodservice Technologies, Inc., Osseo, MN (US); Cornelius (Tianjin) Co., Ltd., Tianjin (CN)

(72) Inventors: Xianli Meng, Tianjin (CN); Zhen Zhang, Tianjin (CN); Weidong Song, Tianjin (CN); Zhujun Ge, Tianjin (CN); Peiyuan Yang, Tianjin (CN); Tinghao Chen, Tianjin (CN); Kyle Kestner, Schaumburg, IL (US); Sohan Birla, Carol Stream, IL (US)

(73) Assignees: Marmon Foodservice Technologies, Inc., Osseo, MN (US); Cornelius (Tianjin) Co., Ltd., Tianjin (CN)

(21) Appl. No.: 19/063,908

(22) Filed: Feb. 26, 2025

(30) Foreign Application Priority Data
Feb. 26, 2024 (CN) 202420354820.X

(51) Int. Cl. A47J 37/06

(52) U.S. Cl. CPC A47J 37/0611

(57) ABSTRACT

A double-sided contact grill, includes an upper heating device and a lower heating device. The upper heating device includes an upper heating plate and an upper heater located on the upper side of the upper heating plate. The lower heating device includes a lower heating plate and a lower heater located on the lower side of the lower heating plate. One of the upper heating device and the lower heating device is a radiant heating device, and the other is a conductive heating device.

### CROSS-REFERENCE TO RELATED APPLICATIONS

The present application claims priority of Chinese Patent Application No. 202420354820.X, filed on Feb. 26, 2024, the contents of which are hereby incorporated by reference in entirety.

### FIELD OF THE DISCLOSURE

The present disclosure relates to the technical field of cooking appliances, and more specifically to a double-sided contact grill.

### BACKGROUND

A double-side contact grill for double-side heating is mainly used for cooking a variety of vegetables, meat products, and other ingredients. At present, most of the commercial double-sided contact grills on the market use electric heating tubes to heat metal surfaces. For a commercial contact grill with power within 5000W, the heating speed is slow, the temperature of the ingredients is limited, more power is consumed, and the continuous production capacity of cooked ingredients is insufficient.

Therefore, additional innovation to available contact grills is needed to address these and/or other constraints.

### BRIEF DISCLOSURE

A series of simplified concepts is introduced herein, which will be further illustrated. This section does not signify an attempt to define the key feature and essential technical feature of the claimed technical solution, let alone determining the protection scope thereof.

To at least partially solve the problem, the present disclosure provides a double-sided contact grill, the double-sided contact grill includes an upper heating device having an upper heating plate and an upper heater located on the upper side of the upper heating plate, and a lower heating device located below the upper heating device and having a lower heating plate and a lower heater located on the lower side of the lower heating plate.

One of the upper heater and the lower heater is an infrared heater for radiant heating of the food by radiating infrared energy to the food, and the other of the upper heater and the lower heater is a contact heater configured to heat the food by conduction between the heating plate and the food to be cooked.

When the lower heater is the infrared radiant heater, the lower heating plate is a transparent member, and the upper heating plate is provided with a high-temperature resistant and anti-sticking layer; when the upper heater is the infrared radiant heater, the upper heating plate is a transparent member, and the lower heating plate is provided with a high-temperature resistant and anti-sticking layer.

Optionally, the material of the transparent member is high-temperature resistant glass.

Optionally, the high-temperature resistant and anti-sticking layer may be a thin sheet anti-sticking member, which can be separately arranged on the upper heating plate or the lower heating plate.

Optionally, the lower heater is an infrared radiant heater, the upper heating device is also provided with a clamping member for clamping the anti-sticking layer, and the clamping member may be located on both sides of the upper heating device in the front-back direction and/or on both sides of the upper heating device in the orthogonal side-side direction.

Optionally, the double-side contact grill further comprises a base and an oil box arranged to one side of the base, the lower heating device is arranged on the top of the base, the top of the base is provided with a baffle around the lower heating plate, the baffle extends to avoid the side where the oil box is located, and a downward concave oil guide groove is provided between the baffle and the lower heating plate and used for collecting grease and debris from cooking of the food thereon and directing it to the oil box.

Optionally, the front end of the base is provided with a control panel, the rear end of the base is pivoted with the upper heating device, and the oil box is arranged on the left or right side of the base.

Optionally, the top of the base is also provided with an inclined oil guide plate located on the side of the lower heating plate near the oil box and used for directing the grease and debris to the oil box.

Optionally, the lower heater is an infrared radiant heater, the lower heating plate is a transparent member, and the upper heating plate is a metal member and is provided with a high-temperature resistant and anti-sticking layer.

Optionally, the infrared radiant heater is an infrared heating tube, and a plurality of the infrared heating tubes are arranged in the front-back direction and arranged at intervals in the left-right direction. The conductive heater includes an electric heater which may include an electric heating tube that has a coiled structure with at least one straight pipe section and a bent pipe section connecting two adjacent straight pipe sections, and the straight pipe section is arranged in the front-back direction and is arranged at intervals in the left-right direction.

Optionally, the double-side contact grill further comprises a fixing assembly for fixing the lower heating plate, the fixing assembly is enclosed in a structure with an opening, the lower heating plate is located at the opening, the fixing assembly has a fixing surface extending horizontally and facing upward, and the lower heating plate is fixed to the fixing surface.

According to the double-side contact grill of the present disclosure, the upper heating device and the lower heating device exhibit different heating operations including infrared radiant heating and conductive heating, thereby constituting the combination of infrared radiant heating and conductive heating. The infrared energy radiated by the infrared radiant heater can directly radiate to the food through the transparent member, such that the food rapidly heats up. Radiant infrared heating method has higher heat utilization efficiency, less heat loss, and less energy consumption for the food to reach the desired cooking temperature, compared to conductive heating alone. The present disclosure can achieve the purpose of rapid heating of food and meet the requirement of continuous production of food, and avoid, by configuring the high-temperature resistant and anti-sticking layer, the phenomenon of food sticking to the conductive heating plate, thereby facilitation of cleaning.

### BRIEF DESCRIPTION OF THE DRAWINGS

The following drawings are hereby incorporated as part of the present disclosure for the understanding of the present disclosure. The embodiments of this disclosure are illustrated and described in the drawings in order to explain the principles of the disclosure.

FIG. 1 is a perspective view of a double-sided contact grill according to the present disclosure, wherein the upper heating device is located at a working position.

FIG. 2 is a top view of the double-sided contact grill shown in FIG. 1.

FIG. 3 is another perspective view of the double-sided contact grill shown in FIG. 1, wherein the upper heating device is located in a non-working position away from the lower heating device.

FIG. 4 is a side view of the double-sided contact grill shown in FIG. 3.

FIG. 5a is a cross-sectional view of the double-sided contact grill shown in FIG. 1.

FIG. 5b is another cross-sectional view of the double-sided contact grill shown in FIG. 1.

FIG. 6 shows an example of an electric heating element for a conductive heating device and an upper heating device housing as exemplarily shown in FIG. 5a.

FIG. 7 shows an example of an infrared radiant heater for a radiant heating device and a lower heating device housing shown in FIG. 5a.

### BRIEF DESCRIPTION OF REFERENCE NUMERALS OF THE DRAWINGS

### EXPLANATION OF REFERENCE SYMBOLS

1: Double-sided contact grill
2: Base
3: Control panel
4: Pivoting part
5: Handle
6a: First pivot
6b: Second pivot
7: Connecting rod assembly
8: Connecting rod
9: Connecting bracket
10a: First rotating shaft
10b: Second rotating shaft
11: Fixing assembly
12: Clamping member
13: Oil Box
14: Baffle
15: Oil guide groove
16: Oil guide plate
17: Straight pipe section
18: Bent pipe section
19: Oil guide member
20: Upper heating device
21: Upper heating plate
22: Upper heater
23: Upper heating device housing
24: Fixing bracket
25: Upper heat insulation part
26: Upper temperature sensor
30: Lower heating device
31: Lower heating plate
32: Lower heater
33: Lower heating device housing
34: Lower heat insulation part
35: Lower temperature sensor
40: High-temperature resistant and anti-sticking layer
42: Front
44: Back
46: Side
48: Side
52: Handle Arms
54: Handle Grip
56: Surface

### DETAILED DISCLOSURE

In the following description, numerous specific details are set forth in order to provide a more thorough understanding of the present disclosure. However, it is obvious to those skilled in this art that the present disclosure may be implemented without one or more of these details. Some technical features well-known in this art are not described in other examples in order to avoid confusion with the present disclosure.

In order to thoroughly understand the present disclosure, a detailed description is provided herein. Implementation of the present disclosure is not limited to the specific details familiar to those skilled in the art. The preferred embodiments of the present disclosure are described in detail as follows. However, in addition to these detailed descriptions, the present disclosure may have other embodiments.

It shall be noted that the terminology used herein is for the purpose of describing particular embodiments only and is not intended to limit the exemplary embodiments of the present disclosure. As used herein, the singular forms are intended to include the plural forms as well, unless the context clearly indicates otherwise. It will be further understood that the terms “comprising” and/or “including,” when used in this specification, specify the presence of stated features, wholes, steps, operations, elements, and/or components, but do not preclude the presence or addition of one or more other features, wholes, steps, operations, elements, components, and/or combinations thereof.

Ordinals such as “first” and “second” quoted in this disclosure are merely identifiers and do not carry any other meaning, such as a specific order. Moreover, for example, the term “first component” itself does not imply the presence of “second component”, and the term “second component” itself does not imply the presence of “first component.”

It should be noted that the terms “up”, “down”, “front”, “back”, “left”, “right”, “inside”, “outside” and similar expressions used herein are for illustrative purposes only and are not restrictive.

The exemplary embodiments of the present disclosure will now be explained in further detail with reference to the accompanying drawings. However, these exemplary embodiments can be implemented in various forms and should not be construed as being limited to the embodiments set forth herein. It is to be understood that these embodiments are provided to make the disclosure of the present disclosure thorough and complete and the concept of these exemplary embodiments be completely delivered to those of ordinary skill in the art.

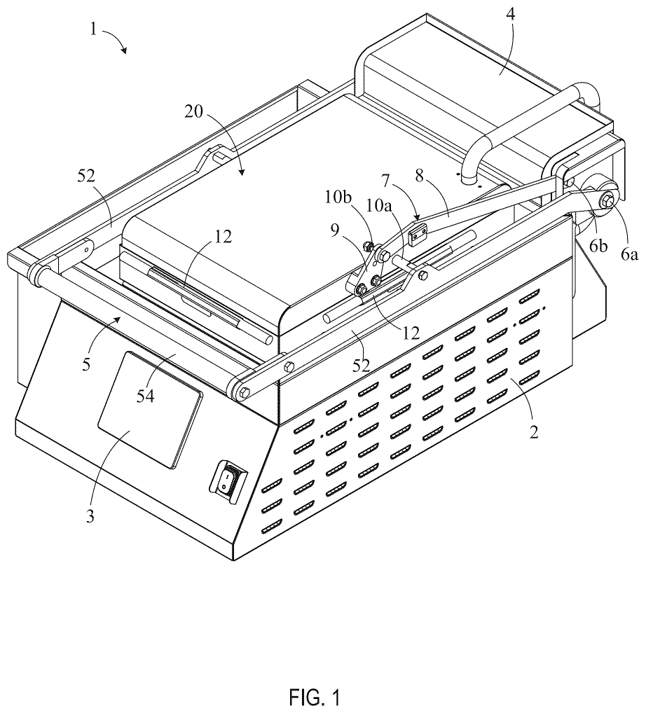

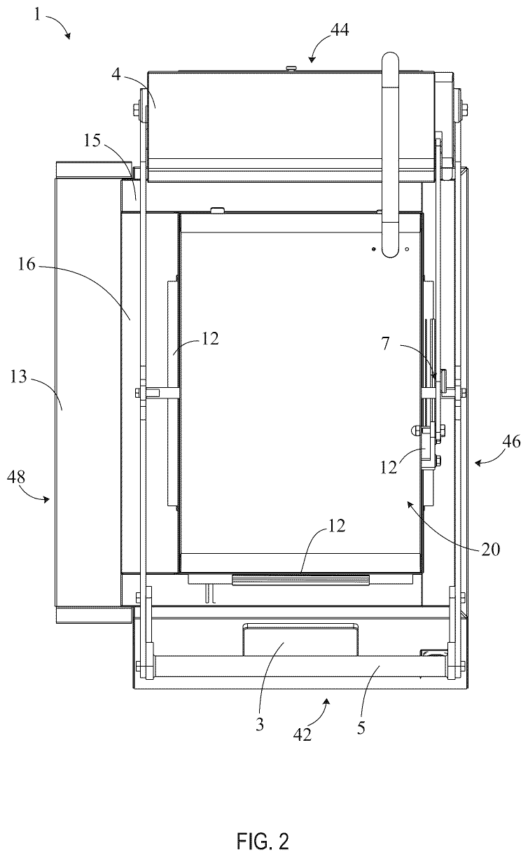

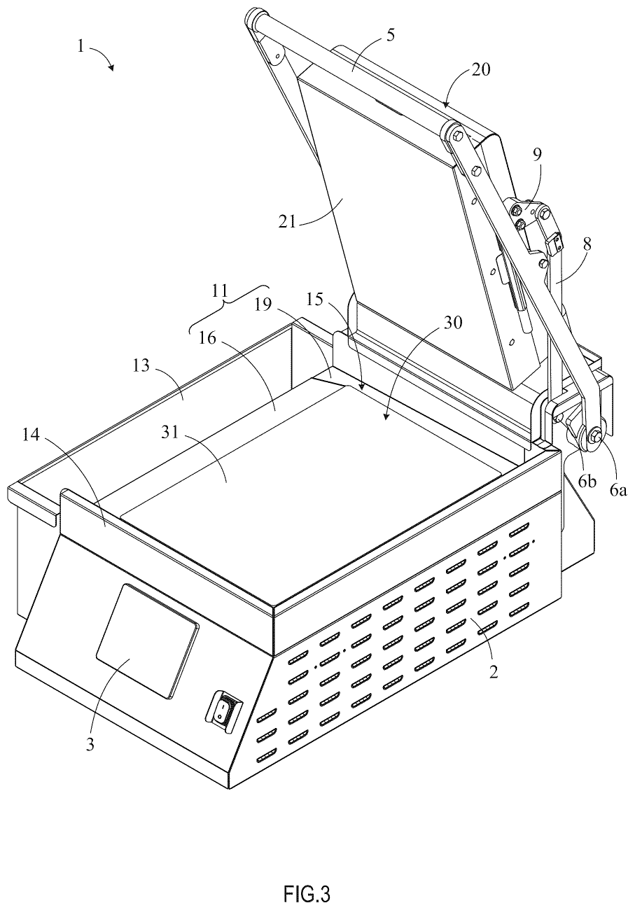

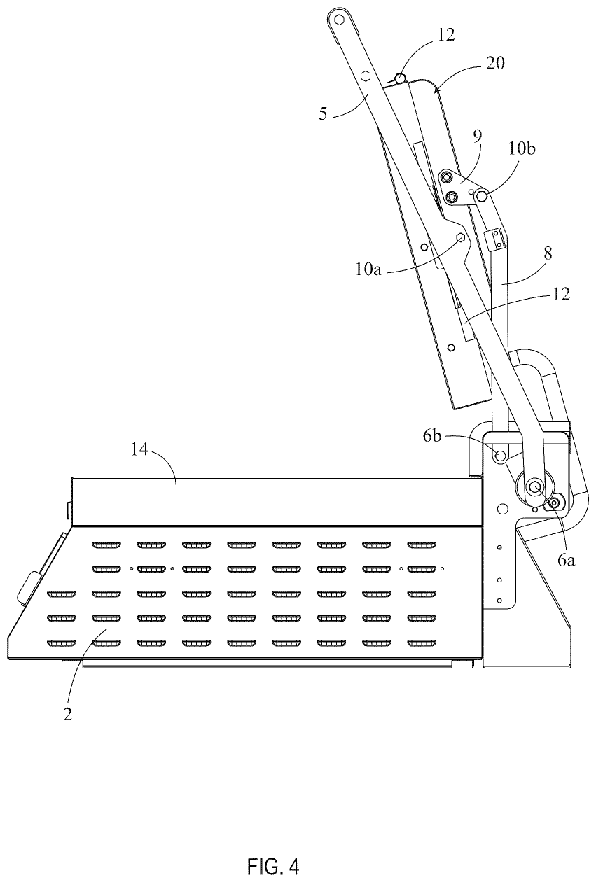

As shown in FIG. 1 to FIG. 5b, the present disclosure provides a double-side contact grill 1, which can be used as a commercial contact grill, such as a commercial contact grill with power exemplarily within 5000W. CN110151009 discloses an example of a contact grill with which examples of the present disclosure may be used and is hereby incorporated by reference in its entirety. The double-sided contact grill 1 includes a base 2 and a lower heating device 30 arranged on top of the base 2. An upper heating device 20 is located vertically above the lower heating device 30 and the base 2. The double sided contact grill I extends between a front 42, a back 44, and opposing sides 46 and 48. The upper heating device 20 is movable relative to the lower heating device 30 and to the base 2. The upper heating device 20 is pivotably connected to the base 2 as described herein and can pivot between a closed or working position near the lower heating device 30 (see FIGS. 1 and 2) and an open or loading position away from the lower heating device 30 (sec FIGS. 3 and 4).

The base 2 is roughly cuboid in shape. The lower heating device 30 is dimensioned to fit on top of and within the perimeter of the base 2 as described in further detail herein. The upper heating device 20 has a size and shape that generally corresponds to that of the lower heating device 30. The front end of the base 2 is provided with a control panel 3, and the rear end of the base 2 is pivotably connected to the upper heating device 20. Exemplarily, the rear end of the base 2 is provided with a pivoting part 4 that extends rearward and above the base 2.

The double-side contact grill 1 further includes a handle 5 that extends forward of the upper heating device 20 and the lower heating device 30 and is further connected to the upper heating device 20 and to the pivoting part 4 as described herein. Handle arms 52 extend rearward from a handle grip 54 and parallel to the upper heating device 20. Opposite the handle grip 54, the handle arms 52 are pivotably connected to the pivoting part 4, which exemplarily provides a torque spring and support brackets (not depicted) to which the handle arms 52 are connected at a first pivot 6a. The handle arms 52 are further pivotally connected to the upper heating device 20 through a first rotating shaft 10a. In an example, the first rotating shaft 10a is connected to the upper heating device 20 centrally in the front-back direction.

In the closed or working position, the upper heating device 20 is generally parallel to the lower heating device 30. The upper heating device 20 is generally horizontal at the closed or working position. Once pivoted to the open or loading position, the upper heating device 20 is tilted relative to the lower heating device 30. The upper heating device 20 is tilted at an angle to the horizontal plane which may be an acute angle, in a not limiting example the angle is 65°.

It should be noted that the directional terms used herein to describe the various components and parts of the double-side contact grill 1, such as “upper”, “lower”, “above”, “below”, “upward”, “downward”, “up” and “down”, are relative to the double-side contact grill 1 in the horizontal and upright state.

In order to make the upper heating device 20 horizontal when pivoted to the closed or working position, the upper heating device 20 is provided with a connecting rod assembly 7. The connecting rod assembly 7 includes a connecting rod 8, a connecting bracket 9, and a second rotating shaft 10b. One end of the connecting rod 8 is pivotably connected to the pivoting part 4 through the second pivot 6b. The opposite end of the connecting rod 8 is pivotably connected with the connecting bracket 9 through the second rotating shaft 10b. The connecting bracket 9 may be fixed to the upper heating device 20 by fasteners such as screws. The fixed position of the connecting bracket 9 is spaced apart from the first rotating shaft 10a in the front-back direction, and the first rotating shaft 10a is located between the connecting piece 9 and the pivoting part 4.

Optionally, the connecting rod assembly 7 is located to one of the sides 46, 48 of the upper heating device 20 and is located between the handle arm 52 and the upper heating device 20. The connecting rod assembly 7 may be located to the side opposite the oil box 13 as described in further detail herein. The first rotating shaft 10a is located below the second rotating shaft 10b in the vertical dimension, which can also be said to be located the connecting rod 8 in the vertical dimension. The first pivot 6a is located on the lower side of the second pivot 6b. The first pivot 6a is forward of or towards the front 42 of the second pivot 6b.

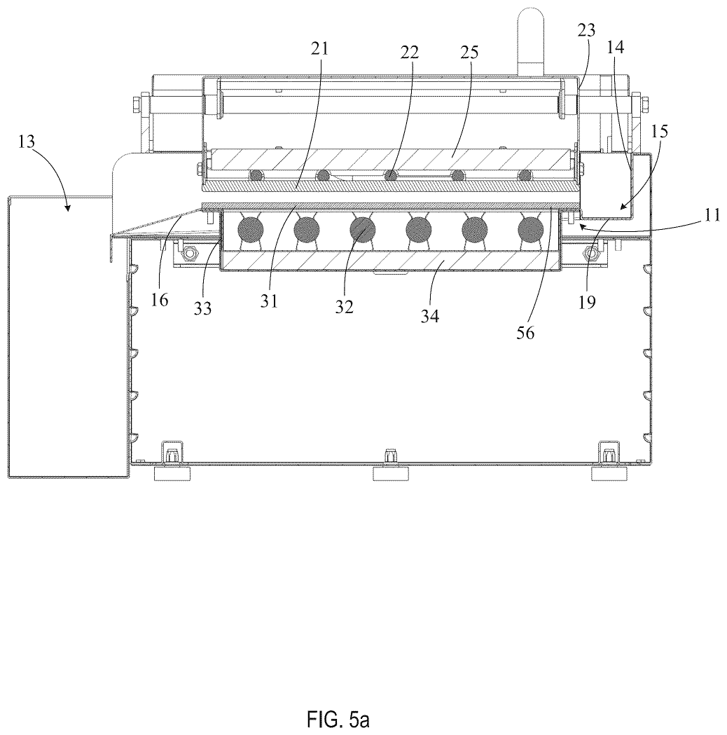

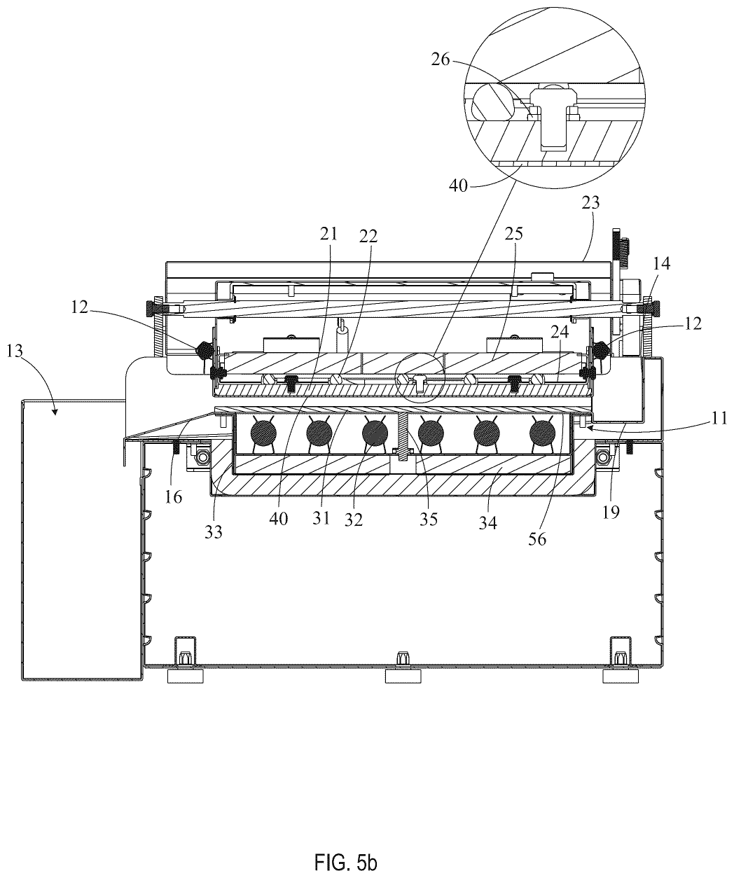

As shown in FIG. 5a, the upper heating device 20 comprises an upper heating plate 21 and an upper heater 22 located on the upper side of the upper heating plate 21. The lower heating device 30 comprises a lower heating plate 31 and a lower heater 32 located on the lower side of the lower heating plate 31. The lower heating plate 31 is used to hold ingredients. When the upper heating device 20 is located at the working or closed position, the upper heating plate 21 is positioned adjacent to the lower heating plate 31, with the ingredients to be cooked positioned between the upper heating plate 21 and the lower heating plate 31.

In this embodiment, the upper heating device 20 and the lower heating device 30 adopt different heating modes including infrared heating and conductive heating, thereby constituting the combination of infrared and conductive heating. Specifically, one of the upper heating device 20 and the lower heating device 30 is an infrared heating device, which is used to radiate infrared rays to the ingredients, and the other of the upper heating device 20 and the lower heating device 30 is a conductive heating device which is used to thermally treat the ingredients by conductive heat transfer from the respective heating plate to the ingredients.

FIGS. 5a and 5b provide non-limiting examples of configurations of the double-sided contact grill 1 wherein the lower heater heating device 30 thermally treats the ingredients with IR energy and the upper heating device 20 thermally treats the ingredients by conduction. The lower heater 32 exemplarily includes at least one CALROD® electrical resistive heating element or at least one ceramic IR emitter. Both of such examples of the heater of the IR heating device use electrical resistance to generate emitted IR energy. In another example, the lower heater 32 exemplarily includes one or more IR-emitting light emitting diodes (LED). Other infrared emitting heaters, including tubular infrared heaters will be recognized based upon the present disclosure. The lower heating plate 31 is exemplarily a transparent member configured for passing the emitted IR energy through to the ingredients. In still further examples, the lower heater 32 may include a microwave source of radiant heating. While the description is provided herein with the radiant heating device, as the lower heating device 30, it will be recognized that in another example, the radiant heating device may be the upper heating device 20. Similarly, while the description is provided herein with the conductive heating device as the upper heating device 20, it will be recognized that in another example, the conductive heating device may be the lower heating device 30.

The infrared ray radiated by the infrared heater can directly radiate to the food through the transparent (to IR energy) lower heating plate 31, such that the food rapidly heats up. Compared with the heating method of heat conduction, the radiant heating method has higher heat utilization efficiency, less heat loss, and less energy consumption for the food to reach the desired cooking temperature. This solution can achieve the purpose of rapid heating of food and meet the requirement of continuous production of food, and avoid, by configuring the high-temperature resistant and anti-sticking layer 40, the phenomenon of food sticking to the heating plate 21 of the conductive heating device (e.g. upper heating device 20), thereby facilitation of cleaning. In another example, the anti-sticking layer 40 may alternatively be a thin metal sheet with a non-stick coating. The non-stick coating may exemplarily be PTFE, ceramic, thin film PVD, or others as may be recognized by one of ordinary skill in the art based upon the present disclosure. In examples, such a think metal sheet construction of the anti-sticking layer may be connected to the plate with a tab at one end and a spring or single catch at an opposite side to secure the anti-sticking layer to the plate.

The illustrative embodiment shows that the lower heating device 30 is a radiant infrared heating device and the upper heating device 20 is a conductive heating device. As previously noted, the lower heating plate 31 is constructed of a material transparent to IR radiant energy. The material of the transparent lower heating plate 3 is exemplarily high-temperature resistant glass, such as glass-ceramics, tempered glass, quartz glass, etc. If needed and/or desired, other transparent materials that are resistant to high temperatures, such as transparent plastics, can also be used. The upper heating plate 21 is provided with the high-temperature resistant and anti-sticking layer 40. Illustrative embodiments are described below, for example.

The heating plate of the conductive heating device, exemplarily the upper heating plate 21 of the upper heating device 20 is a metal member, such as stainless steel, iron, etc. Selecting the metal heating plate with good thermal conductivity can quickly conduct heat to food. If needed and/or desired, the heating plate of other materials and good thermal conductivity can also be used, such as ceramic heating plates, etc.

The heater, e.g. upper heater 22, used to heat the heating plate for conductive thermal treatment of the ingredients may include any of a variety of systems. The heater 22 may exemplarily be a CALROD® electrical resistive heating element, a ceramic electrical resistive heating element, resistive electrical wire elements, or think and/or thick film resistive trace or wire elements. The film may exemplarily be deposed or printed on the heating plate. Heat generated by the resistance of any of these devices to electrical current is transferred into the heating plate. In a still further arrangement, one of the above heating elements are arranged within a block of a conductive metal, and the heating plate 21 is removably connected to the block of conductive metal and/or removably connected to the heater 22. In still further examples, the heater 22 is an inductive heater, which elevates the temperature of the heating plate 21 by inducing current within the heating plate with generated magnetic fields. This inductively generated heat is transferred to the ingredients by conduction between the heating plate 21 and the ingredients.

Referring to FIG. 3 as well as FIGS. 5a and 5b, the double-side contact grill 1 further includes a fixing assembly 11 for fixing the lower heating plate 31 to the body 2. The fixing assembly 11 is enclosed in a structure with an opening, and the lower heating plate 31 may be arranged on a structure having an opening, wherein the lower heating plate 31 is located at the opening of the fixing assembly 11. The fixing assembly 11 has a fixing surface 56 extending horizontally and facing upward, and the lower heating plate 31 is fixed to the fixing surface 56. For illustrative embodiments, for example, the transparent member may be disposed on the fixing surface by means of bonding. In an example, the fixing surface 56 of the fixing assembly 11 may include an opening through which the IR energy passes to the lower heating plate 31. The fixing assembly 11 is connected to the top housing of the base 2.

As is further depicted, and described herein, the fixing assembly 11 may further include and/or be unitary with portions of the grease management features described herein. The fixing assembly 11 may further extend outwards in a generally horizontal direction in one or more oil guide members 19 to form an oil guide groove 15 about two or more sides of the lower plate 31. The oil guide groove may be in the shape of a downward concave and extend below the lower plate between the lower plate 31 and the baffle 14. In an example, the oil guide member may be a same or unitary piece of material as the baffle 14. This construction may help to limit infiltration of grease and debris inside of the fixing assembly 11 and body 2.

With reference to FIG. 3, the double-side contact grill 1 further comprises an oil box 13 arranged on one side of the base 2, for example, the oil box 13 is arranged on one of the opposing sides 46, 48 of the base 2. The oil box 13 is exemplarily located to a side opposite the connecting rod assembly 7. The illustrative embodiment schematically shows that the oil box 13 is arranged towards side 48 of the base 2, although it will be recognized that the oil box 13 may be arranged towards side 46 as well. The top of the base 2 is provided with a baffle 14 around the lower heating plate 31, and the baffle 14 extends about the other sides of the lower heating plate 31 exemplarily except for the side where the oil box 13 is located. In other words, the baffle 14 is not arranged on the side where the oil box 13 is located. A downward concave oil guide groove 15 is provided between the baffle 14 and the lower heating plate 31 and used for collecting grease and debris from cooking the ingredients and directing it to the oil box 13. For the illustrated embodiment, the oil guide groove 15 is located between the lower heating plate 31 and the baffle 14. The oil guide member 19 forming the oil guide groove 15 and the baffle 14 are integrally formed. It should be noted that the baffle 14 forms the outer groove wall of the oil guide groove 15, and the oil guide member 19 forms the inner groove wall and bottom wall of the oil guide groove 15. By means of the oil guide groove 15, the grease and debris from the ingredients cooking on the lower heating plate 31 can be collected, and then easily flow to the oil box 13 to avoid the grease and debris from accumulating on or about the lower heating plate 31. In a still further example, the lower heating plate 31 is angled towards the oil box, such as to further direct grease and debris away from the lower heating plate 31 and into the oil box 13.

The top of the base 2 is also provided with an inclined oil guide plate 16 located on the side of the lower heating plate 31 near the oil box 13 and used for directing the grease and debris to the oil box 13. For the illustrated embodiment, the top end of the oil guide plate 16 is a part of the fixing assembly 11 and is connected to the lower heating plate 31. By means of the oil guide plate 16, oil accumulation on the lower heating plate 31 can be further avoided. Furthermore, the baffle 14, the oil guide plate 16 and the oil guide member 19 constitute the fixing assembly 11.

The high-temperature resistant and anti-sticking layer 40 consists of a thin sheet anti-sticking member, such as a paper member. Optionally, Teflon paper is used as an anti-sticking member. The anti-stick member in the illustrated embodiment can be separately arranged on the upper heating plate 21 such that the anti-sticking member can be removed from the heating device for replacement. In order to facilitate the installation of the anti-sticking member, with reference to FIG. 1, the upper heating device 20 is also provided with a clamping member 12 for clamping the anti-sticking member, and the clamping member 12 is located on both sides of the upper heating device 20 in the front-back direction and/or on both sides in the left-right direction. Furthermore, the side of the upper heating device 20 is provided with one or two pairs of clamping members 12, each pair of the clamping members 12 is on the opposite side of the upper heating device 20. FIG. 1 schematically shows that the upper heating device 20 is provided with a clamping member 12 on both sides in the front-back direction and on both sides of the upper heating device in the left-right direction.

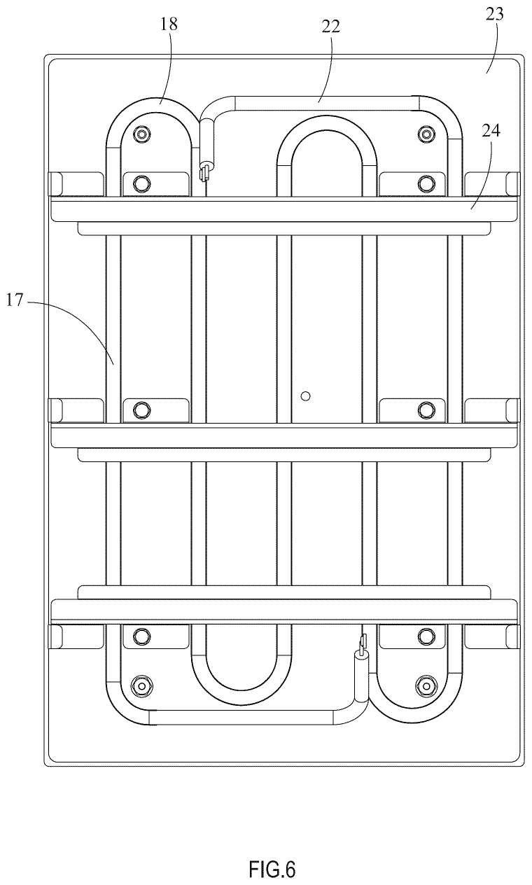

As shown in FIG. 6, the upper heater 22 is exemplarily an electric heating tube that has a coiled structure. Such a resistive electric heating tube may be known under the CALROD® brand. The heating tube exemplarily encloses a resistive wire within a metal casing and magnesium oxide insulation, however other constructions of resistive heating tubes will be recognized by a person of ordinary skill in the art. The upper heater 22 is not limited to such a configuration, the shape and pattern of the electric heating tube may take any arrangement as recognized by a person of skill in the art, for example to achieve the power usage or heat distribution requirements for the grill 1. For a rectangular heating device, the electric heating tube has a straight pipe segment 17 and a bent pipe segment 18 connecting two adjacent straight pipe segments 17. The straight pipe segment 17 is arranged in the front-back direction and is arranged at intervals in the left-right directions. With such a setting, the heating plate heated by the electric heating tube can be heated more evenly, which is conducive to uniform heating of food.

The upper heating device 20 further comprises an upper heating device housing 23 and a fixing bracket 24. The upper heater 22 is located in the upper heating device housing 23 and is fixed by the fixing bracket 24. Specifically, the fixing bracket 24 is connected to the upper heating device housing 23, and the electric heater is fixed on the fixing bracket 24. The fixing bracket 24 further facilitates a physical connection between the upper heater 22 and the upper heating plate 21. The upper heating plate 21 may be removably secured to the fixing bracket 24 and may include an interchangeable heating plate 21 to facilitate cleaning and/or servicing of the heating plate 21.

The upper heating device 20 further comprises an upper heat insulation part 25 (sec FIG. 5a) and an upper temperature sensor 26 (see FIG. 5b). The upper heat insulation part 25 is located on the upper side of the upper heater 22 (e.g. the side of the upper heater 22 opposite the upper heating plate 21) for insulating heat and avoiding the heat generated by the upper heater 22 from dissipating upward so as to improve heating efficiency. The material of the upper heat insulation part 25 can be selected from thermal insulation cotton, etc. The upper temperature sensor 26 is used to detect the temperature of the upper heating plate 21 to provide as feedback for control of the operation of the upper heater 22 to achieve a target temperature of the heating plate 21. It will be recognized that one or more temperature sensors 26 may be used to determine the temperature of the upper heating plate 21. In a further example, radiated IR energy that passes through the lower heating plate 31 and doesn't enter the ingredients in the grill to be cooked, passes through to the upper heating plate 21, where instead of being lost, this energy is absorbed by the upper heating plate 21, increasing its temperature and reducing energy needed from the upper heater 22 to maintain the target temperature of the upper heating plate 21.

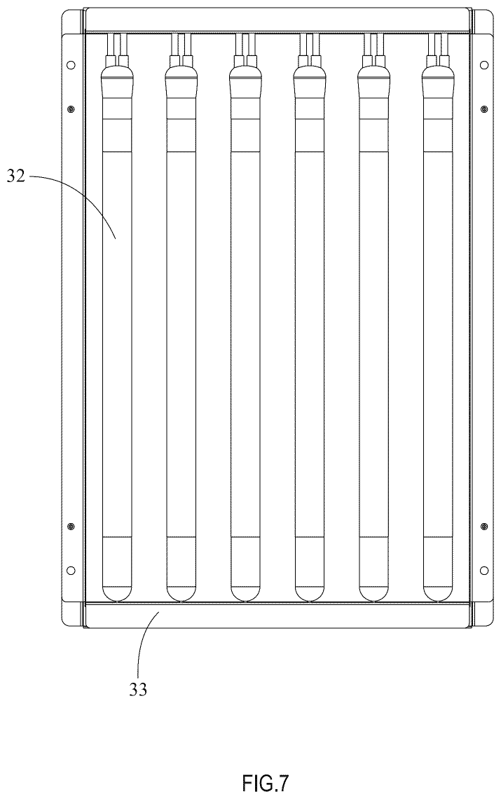

As shown in FIG. 7, the infrared heater is an infrared heating tube, and a plurality of the infrared heating tubes are arranged in the front-back direction and arranged at intervals in the left-right direction. The infrared heating tube may exemplarily be a quartz lamp, for example with a tungsten or nickel-chrome alloy element within a sealed tube which may be filled with halogen. With such a setting, the heating plate heated by the infrared heating tube can be heated more evenly, which is conducive to uniform heating of food.

The lower heating device 30 further comprises the lower heating device housing 33. The lower heater 32 is located in the lower heating device housing 33 and is supported in the lower heater housing 33. For the illustrated embodiment, for example, the infrared heating tube may be secured to the lower heating device housing 33 by a buckle. The lower heating device housing 33 is connected to the fixing assembly 11, in particular to the oil guide plate 16 and the oil guide member 19, which may be connected, for example, by a fastener such as a screw. The connection method is certainly not limited, which can be selected according to needs.

The lower heating device 30 further comprises a lower heat insulation part 34 (sec FIG. 5a) and a lower temperature sensor 35 (see FIG. 5b). The lower heat insulation part 34 is located on the lower side of the lower heater 32 for insulating heat and avoiding the heat generated by the lower heater 32 from dissipating downward so as to improve heating efficiency. The material of the lower heat insulation part 34 can be selected from thermal insulation cotton, etc. The lower temperature sensor 35 is used to detect the temperature of the lower heater 32 in order to control the temperature of the lower heater 32.

Working process of the double-side contact grill 1.

Start the upper heater 22 and the lower heater 32 first, and preheat the upper heating plate 21 and the lower heating plate 31, for example, for a few minutes.

The food is then to be cooked after the upper temperature sensor 26 detects that the upper heater 22 reaches the first set temperature, and the upper temperature sensor 26 detects that the upper heater 22 reaches the second set temperature.

Next, ingredients are put, the upper heating device 20 is pivoted to the working position, and the ingredients is quickly heated.

Afterwards, after reaching the set time, the upper heating device 20 is pivoted to the non-working position to take out the cooked food.

Unless otherwise defined, the technical and scientific terms used herein have the same meanings as commonly understood by those skilled in the technical field of the present disclosure. The terms used herein are only for describing specific implementation purposes, and are not intended to limit the present disclosure. A feature described in one embodiment herein can be applied to another embodiment alone or in combination with other features, unless the feature is not applicable in the other embodiment or otherwise stated.

The present disclosure has been described through the above-mentioned embodiments, but it should be understood that the above-mentioned embodiments are only for the purpose of illustration and description, and are not intended to limit the present disclosure. More variations and modifications can be made according to the teachings of the present disclosure, and these variations and modifications fall within the protection scope claimed by the present disclosure.

1. A double-sided contact grill, comprising:
an upper heating device comprising an upper heating plate and an upper heater located on an upper side of the upper heating plate; and
a lower heating device located below the upper heating device and comprising a lower heating plate and a lower heater located on a lower side of the lower heating plate,
wherein one of the upper heater and the lower heater is an infrared heater for radiating infrared ray to food, and the other of the upper heater and the lower heater is an electric heater,
when the lower heater is the infrared heater, the lower heating plate is a transparent member, and the upper heating plate is provided with a high-temperature resistant and anti-sticking layer; when the upper heater is the infrared heater, the upper heating plate is a transparent member, and the lower heating plate is provided with a high-temperature resistant and anti-sticking layer.

2. The double-sided contact grill of claim 1, wherein a material of the transparent member is high-temperature resistant glass.

3. The double-sided contact grill of claim 1, wherein the high-temperature resistant and anti-sticking layer consists of a thin sheet anti-sticking member, which can be separately arranged on the upper heating plate or the lower heating plate.

4. The double-sided contact grill of claim 3, wherein the lower heater is an infrared heater, the upper heating device is also provided with a clamping member for clamping the anti-sticking layer, and the clamping member is located on both sides of the upper heating device in a front-back direction and/or on both sides of the upper heating device in a side-side direction.

5. The double-sided contact grill of claim 1, wherein the double-side contact grill further comprises a base and an oil box arranged on one side of the base, the lower heating device is arranged on the base, the base is provided with a baffle around the lower heating plate, the baffle extends to avoid the side where the oil box is located, a downward concave oil guide groove is provided between the baffle and the lower heating plate and used for collecting grease and debris and directing it to the oil box.

6. The double-sided contact grill of claim 5, wherein a front end of the base is provided with a control panel, a rear end of the base is pivoted with the upper heating device, and the oil box is arranged to a side of the base.

7. The double-sided contact grill of claim 5, wherein the base is also provided with an inclined oil guide plate located on the side of the lower heating plate near the oil box and used for directing the grease and debris to the oil box.

8. The double-sided contact grill of claim 1, wherein the lower heater is an infrared heater, the lower heating plate is a transparent member, and the upper heating plate is a metal member and is provided with a high-temperature resistant and anti-sticking layer.

9. The double-sided contact grill of claim 1, wherein the infrared heater is an infrared heating tube, and a plurality of the infrared heating tubes are arranged in a front-back direction and arranged at intervals in a side-side direction; and
the electric heater is an electric heating tube that has a coiled structure and a straight pipe section and a bent pipe section connecting two adjacent straight pipe sections, and the straight pipe section is arranged in the front-back direction and is arranged at intervals in a side-side direction.

10. The double-sided contact grill of claim 1, further comprising a fixing assembly for fixing the lower heating plate, the fixing assembly is enclosed in a structure with an opening, the lower heating plate is located at the opening, the fixing assembly has a fixing surface extending horizontally and facing upward, and the lower heating plate is fixed to the fixing surface.

11. A double-side contact grill, comprising:
a conductive heating device comprising a conductive plate and a first heating device configured to heat the conductive plate;
a radiant heating device comprising a plate having a transparent member and a second heating device configured to emit radiation energy through the transparent member of the plate; and
a handle assembly configured to move the conductive heating device and the radiant heating device between a closed position wherein the conductive plate and the plate having a transparent member are generally parallel and configured to hold an ingredient to be cooked therebetween, and an open position wherein the conductive plate and the plate having a transparent member are angled to one another and configured to receive an ingredient to be cooked therein.

12. The double-sided contact grill of claim 11, wherein the radiant heating device is a lower heating device secured to a base of the double-sided contact grill, and the conductive heating device is an upper heating device pivotably connected to the base and configured to move relative to the base between the open position and the closed position.

13. The double-sided contact grill of claim 12, further comprising:
an oil box arranged to a first side of the base;
a baffle extending from the base exterior of the plate having the transparent member and above the transparent member; and
an oil guide plate defining an oil guide groove between the plate having the transparent member and the baffle at least partially about a perimeter of the plate having the transparent member.

14. The double-sided contact grill of claim 13, wherein the plate having the transparent member is angled towards the oil box.

15. The double-sided contact grill of claim 11, further comprising a high-temperature resistant and anti-sticking layer removably connected to the conductive plate.

16. The double-sided contact grill of claim 11, wherein the first heating device is a resistive heating device comprising at least one heating element selected from a tubular electrical resistive heating element, a ceramic electrical resistive heating element, a resistive electrical wire element, and a thin or a thick film resistive trace or wire element.

17. The double-sided contact grill of claim 11, wherein the first heating device is an inductive heating device.

18. The double-sided contact grill of claim 11, wherein the second heating device is a microwave heating device.

19. The double-sided contact grill of claim 11, further comprising at least one temperature sensor in thermal contact with the conductive plate, wherein the conductive plate further receives heat energy from the second heating device and the first heating device is configured to be operated based upon a temperature from the at least one temperature sensor.

20. The double-sided contact grill of claim 11, further comprising:
a base supporting the conductive heating device and the radiant heating device;
an oil box arranged to a first side of the base;
a baffle extending upwards from a perimeter of the base, wherein the conductive heating device and the radiant heating device are interior of the perimeter of the base and interior of the baffle; and
an oil guide plate defining an oil guide groove interior of the baffle and angled towards the oil box;
wherein one of the conductive heating device and the radiant heating device is fixed to the base and thee other of the conductive heating device and the radiant heating device is pivotable relative to the base.
